(19) United States
(12) Patent Application Publication
(10) Pub. No.: US 2008/0252961 A1
(43) Pub. Date: Oct. 16, 2008

(54) Optical transceiver

(75) Inventors: Akitoshi Mesaki, Kawasaki (JP); Masaki Kuribayashi, Kawasaki (JP); Kentarou Yoshizaki, Kawasaki (JP); Takashi Yamane, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/998,402

(22) Filed: Nov. 30, 2007

(30) Foreign Application Priority Data
Apr. 13, 2007 (JP) 2007-106093

(51) Int. Cl. G02F 1/09

(52) U.S. Cl. 359/281

(57) ABSTRACT

In an optical transceiver of the invention, a magnet-free Faraday rotator is arranged on an optical axis between a light-emitting part and an end face of an optical fiber, and after rotating a plane of polarization of light of a first wavelength output from the light-emitting part, the light is input to a polarization dependent wavelength-separating film as P-polarized light. The polarization dependent wavelength-separating film has a characteristic of passing the P-polarized light of the first wavelength, and reflecting S-polarized light of the first wavelength and light of a second wavelength output from the optical fiber. As a result it is possible to provide a single-core bidirectional optical transceiver that can be shortened in overall length, with a low loss and without affecting transfer characteristics.

### BACKGROUND OF THE INVENTION

1. Field of the Invention

The present invention relates to an optical transceiver used for optical fiber communication, and more specifically, relates to an optical transceiver that uses a single-core optical fiber to transfer beams transmitted in both directions.

2. Description of the Related Art

FIG. 6 is a cross-sectional view showing a configuration example of a conventional single-core bidirectional optical transceiver.

In the conventional optical transceiver in FIG. 6, a light-emitting part 110 is fixed to one end of a housing 161, and a beam L1 output from the light-emitting part 110 is input to an optical isolator 120. The optical isolator 120 includes a polarizer 121 arranged in a direction of an optical axis of the input beam L1, a Faraday rotator 122 and an analyzer 123, and a magnet 124 that applies a constant magnetic field to the Faraday rotator 122. A case 125 for storing these is fixed inside the housing 161, for example, by bonding or welding. In some cases, the case 125 may be fixed to the light-emitting part 110. The optical isolator 120 has a function of transmitting the beam L1 from the light-emitting part 110 and inhibiting reflected and returned beams to the light-emitting part 110. The beam L1 which has passed through the optical isolator 120 is input to an optical fiber 140 via a wavelength separator 130. The wavelength separator 130 is one where a wavelength-separating film 131 having a transmission wavelength characteristic, for example as shown in FIG. 7, is formed on a transparent flat plate 132, and this is fixed by bonding to a predetermined position inside the housing 161. The beam L1 of wavelength λ1 is transmitted through the wavelength-separating film 131 and a beam L2 of wavelength λ2 is reflected by the wavelength-separating film 131. The optical fiber 140 has a ferrule 141 surrounding an end portion thereof, and is fixed to the other end of the housing 161 via a ferrule holding member 162. The beam L2 of wavelength λ2 propagating inside the optical fiber 140 in an opposite direction to the beam L1 and output from an end face of the optical fiber 140, is reflected by the wavelength-separating film 131 and input to a light-receiving part 150. The light-receiving part 150 is fixed to a side face of the housing 161, and condenses the reflected light from the wavelength-separating film 131 with a lens, and receives the condensed light with a photodetector. As a result, single-core bidirectional optical communication is realized (for example, refer to Japanese Unexamined Patent Publication Nos. 2000-180671 and 2005-222050).

And now, in an optical transceiver having the optical transmitter and the optical receiver as shown in FIG. 6 mounted thereon, high-density packaging by system miniaturization is becoming predominant, and demand for miniaturization of the optical transceiver is becoming strong. More specifically, the optical transceiver is shifting to a pluggable format, and shortening of the overall length of the optical transceiver becomes one of the most important problems.

As a measure for realizing shortening of the overall length in the configuration of the abovementioned conventional optical transceiver; for example, it can be considered to use the light-emitting part 110 mounted with a lens having a short focal length, to thereby to shorten a distance between the light-emitting part 110 and the end face of the optical fiber 140. However, a space for inserting the optical isolator 120 and the wavelength separator 130, and a space for adjusting the position of the end face of the optical fiber 140 in the direction of the optical axis corresponding to variations in the focal length of the light-emitting part 110 need to be ensured on the optical axis between the light-emitting part 110 and the end face of the optical fiber 140. Hence, there is a restriction in shortening of the overall length by the above measure. For example, the insertion space of the optical isolator 120 is explained in detail. When a generally available optical isolator is used, a physical space of about 1.5 mm is required between the light-emitting part 110 and the end face of the optical fiber 140. Moreover, when an optical path length is preliminarily calculated from a standpoint of refractive index (about 1.5 to 2.3), a space of about 2 mm is required.

Furthermore, for the configuration of the aforementioned conventional optical transceiver, a plurality of adjustments of a plane of polarization and an incident position is required. More specifically: (1) the optical isolator 120 including the polarizer 121, the Faraday rotator 122 and the analyzer 123 is arranged between the light-emitting part 110 and the wavelength-separating film 131, and the optical isolator 120 needs to be rotated and adjusted so that the plane of polarization of the output beam L1 having a specific plane of polarization from the light-emitting part 110 is made to match with the plane of polarization of the polarizer 121 in the optical isolator 120; and (2) the wavelength-separating film 131 needs to be rotated and adjusted for making the beam L2 enter into the light-receiving part 150, while guiding the beam L1 to the optical fiber 140.

### SUMMARY OF THE INVENTION

In view of the above situation, it is an object of the present invention to provide a single-core bidirectional optical transceiver that can be shortened in overall length, with a low loss and without affecting transfer characteristics.

To achieve the above object, the present invention provides an optical transceiver that transmits light of a first wavelength to an optical fiber, and receives light of a second wavelength different to the first wavelength transmitted inside the optical fiber in an opposite direction to the light of the first wavelength. The optical transceiver comprises: a light-emitting part that outputs linearly polarized light of the first wavelength towards an end face of the optical fiber; a Faraday rotator arranged on an optical axis between the light-emitting part and the end face of the optical fiber, for rotating a plane of polarization of light propagating in parallel with the optical axis, in one direction by about 45 degrees; a polarization dependent wavelength separator positioned on the optical axis between the Faraday rotator and the end face of the optical fiber, and arranged so that the light of the first wavelength output from the light-emitting part and that has passed through the Faraday rotator, enters therein as P-polarized light, and which has such characteristics that it transmits the P-polarized light of the first wavelength and emits this in the same direction as the optical axis, and reflects S-polarized light of the first wavelength and the light of the second wavelength and emits the reflected light in a direction different from the optical axis; and a light-receiving part that receives the light of the second wavelength output from the end face of the optical fiber and reflected by the polarization dependent wavelength separator.

In the optical transceiver having such a configuration, the linearly polarized light of the first wavelength output from the light-emitting part is input to the Faraday rotator, and after the plane of polarization is rotated in one direction by about 45 degrees, the polarized light is made to enter into the polarization dependent wavelength separator as P-polarized light, transmitted through the polarization dependent wavelength separator and input to the end face of the optical fiber. On the other hand, the light of the second wavelength transmitted inside the optical fiber in the opposite direction to the light of the first wavelength is output from the end face of the optical fiber, reflected by the polarization dependent wavelength separator and received by the light-receiving part. The reflected and returned light of the first wavelength propagating inside the optical fiber is output from the end face of the optical fiber in a random polarization state and enters into the polarization dependent wavelength separator. The P-polarized component thereof is transmitted through the polarization dependent wavelength separator and enters into the light-emitting part, with the plane of polarization thereof rotated in one direction by about 45 degrees by the Faraday rotator. However, since the plane of polarization of the reflected and returned light is orthogonal to the plane of polarization of the light generated in the light-emitting part, it does not have a substantial influence on the operation of the light-emitting part.

According to the optical transceiver of the present invention as described above, the number of optical parts can be reduced, while maintaining similar functions to those of the conventional optical transceiver, thereby enabling realization of shortening of the overall length by reducing the space which must be ensured between the light-emitting part and the end face of the optical fiber. As a result a small single-core bidirectional optical transceiver that can be mounted on a pluggable module can be provided.

Other objects, features, and advantages of the present invention will become apparent from the following description of embodiments, in association with the appended drawings.

### BRIEF DESCRIPTION OF THE DRAWINGS

FIG. 1 is a cross-sectional view showing a configuration of an optical transceiver according to a first embodiment of the present invention.

FIG. 2 is a diagram showing transmission characteristics of a polarization dependent wavelength-separating film in the first embodiment.

FIG. 3 is a cross-sectional view showing a configuration of an optical transceiver according to a second embodiment of the present invention.

FIG. 4 is a diagram showing transmission characteristics of a wavelength-separating film in the second embodiment.

FIG. 5 is a cross-sectional view showing a configuration of an optical transceiver according to a third embodiment of the present invention.

FIG. 6 is a cross-sectional view showing a configuration example of a conventional single-core bidirectional optical transceiver.

FIG. 7 is a diagram showing one example of characteristics of the wavelength-separating film in the conventional optical transceiver.

FIG. 8 is a diagram showing a relation between rotation angle and loss of light of a first wavelength in the first embodiment.

### DETAILED DESCRIPTION OF THE INVENTION

Hereunder is a description of a best mode for carrying out the present invention, with reference to the appended drawings. The same reference symbols denote the same or equivalent parts throughout all of the drawings.

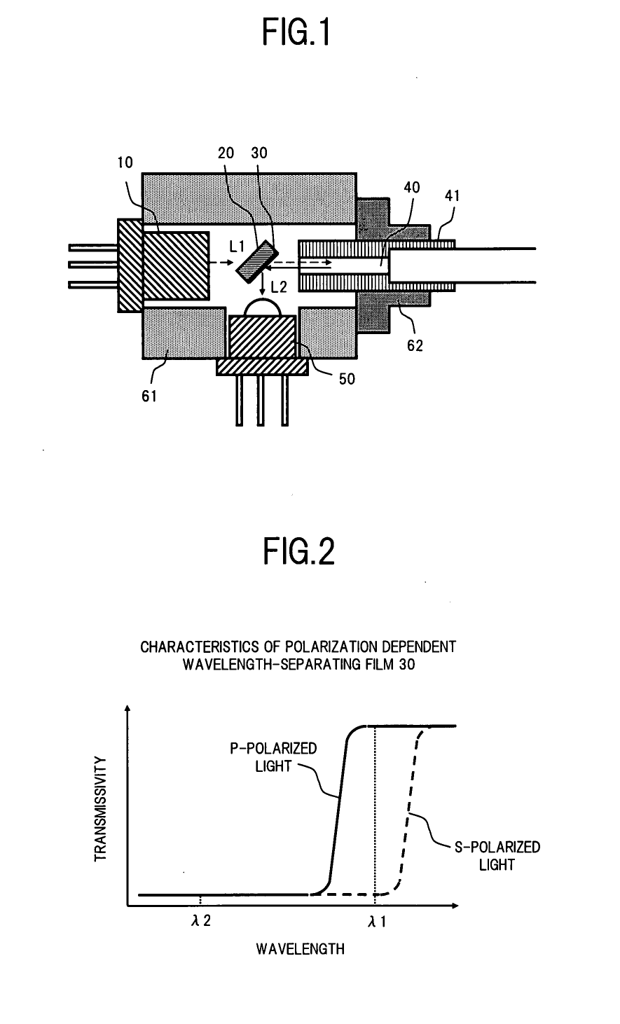

FIG. 1 is a cross-sectional view showing a configuration of an optical transceiver according to a first embodiment of the present invention.

In FIG. 1, the optical transceiver according to the first embodiment comprises, for example, a light-emitting part 10, a magnet-free Faraday rotator 20, a polarization dependent wavelength-separating film 30, an optical fiber 40, a ferrule 41, a light-receiving part 50, a housing 61, and a ferrule holding member 62.

The light-emitting part 10 outputs linearly polarized light L1 of a first wavelength λ1 (for example, 1.49 μm) emitted by a semiconductor laser (LD) or the like, towards an end face of the optical fiber 40. The light-emitting part 10 is fixed to one end of the housing 61, for example, by welding.

The magnet-free Faraday rotator 20 is a Faraday rotator arranged on the optical axis between the light-emitting part 10 and the end face of the optical fiber 40, which can rotate the plane of polarization of light propagating in parallel with the optical axis in one direction by about 45 degrees without requiring a magnet. For example, a Magnet-Free Faraday Rotator FR manufactured by GRANOPT Co. Ltd. can be used.

The polarization dependent wavelength-separating film 30 is an optical device formed on a plane positioned on the optical fiber 40 side of the magnet-free Faraday rotator 20, and the transmission characteristics thereof have wavelength dependence and polarization dependence. FIG. 2 is a diagram showing the transmission characteristics of the polarization dependent wavelength-separating film 30. As seen here, the polarization dependent wavelength-separating film 30 has different transmission wavelength characteristics for the P-polarized light (solid line) and for the S-polarized light (broken line) near the wavelength λ1, and the P-polarized light of the light L1 having the wavelength λ1 is transmitted, but the S-polarized light thereof is reflected. Moreover the light L2 having the wavelength λ2 is reflected regardless of the polarization state. As a specific example of the polarization dependent wavelength-separating film 30, a dichroic prism manufactured by Epson Toyocom Corporation can be used.

The magnet-free Faraday rotator 20 having the polarization dependent wavelength-separating film 30 formed on one plane thereof is fixed at a predetermined position in the housing 61, in a state with a normal direction of the plane on which the polarization dependent wavelength-separating film 30 is formed inclined by about 45 degrees with respect to the direction of the optical axis of the light L1 from the light-emitting part 10, and so that the light L1 polarized and rotated by about 45 degrees by the magnet-free Faraday rotator 20 is provided to the polarization dependent wavelength-separating film 30 as the P-polarized light.

The optical fiber 40 has the ferrule 41 surrounding the end portion thereof, and is fixed to the other end of the housing 61 via the ferrule holding member 62. The position of the end face of the optical fiber 40 is adjusted on the optical axis so that the light L1 from the light-emitting part 10 enters into the end face thereof at a required coupling efficiency, by adjusting the fixed position of the ferrule holding member 62 corresponding to the fixed position of the light-emitting part 10 relative to the housing 61, and adjusting the fixed position of the ferrule 41 inside the ferrule holding member 62 corresponding to a focal length of a lens (not shown in the figure) built into the light-emitting part 10.

The light-receiving part 50 is a general optical part that condenses the light reflected by the polarization dependent wavelength-separating film 30 with a lens, and receives light with a photodetector (not shown in the figure), and is fixed to the side face of the housing 61, for example, by welding.

Next is a description of the operation of the first embodiment.

In the optical transceiver having the above-described configuration, the linearly polarized light L1 of wavelength λ1 output from the light-emitting part 10 is input to the magnet-free Faraday rotator 20, and after the plane of polarization is rotated in one direction by about 45 degrees, the polarized light is provided to the polarization dependent wavelength-separating film 30. At this time, since the polarization dependent wavelength-separating film 30 is arranged so that the incident light L1 becomes P-polarized light, the light L1 of wavelength λ1 is transmitted through the polarization dependent wavelength-separating film 30, as shown by the solid line in FIG. 2, reaches the end face of the optical fiber 40, and propagates inside the optical fiber 40.

On the other hand, the light of wavelength λ2 transmitted inside the optical fiber 40 in the opposite direction to the light L1 of wavelength λ1 is output from the end face of the optical fiber 40 in a random polarization state, and reaches the polarization dependent wavelength-separating film 30. The light L2 of wavelength λ2 entering into the polarization dependent wavelength-separating film 30 is reflected by the polarization dependent wavelength-separating film 30, since as shown in FIG. 2, the polarization dependent wavelength-separating film 30 has a low transmissivity relative to the light L2 of wavelength λ2 in an arbitrary polarization state, and a traveling direction thereof is bent approximately at right angles, and the light is received by the light-receiving part 50. At this time, since the magnet-free Faraday rotator 20 is used, a magnet having a complicated structure need not be used to ensure an optical path of the light L2.

Moreover, the light L1 of wavelength λ1 propagating inside the optical fiber 40 may be reflected by an external factor, and the returned light thereof may be output from the end face of the optical fiber 40. In this case, the reflected and returned light of wavelength λ1 enters into the polarization dependent wavelength-separating film 30 in the random polarization state. Components corresponding to the P-polarized light of the polarization dependent wavelength-separating film 30 are transmitted through the polarization dependent wavelength-separating film 30, and components corresponding to the S-polarized light are reflected by the polarization dependent wavelength-separating film 30. The reflected and returned light of wavelength λ1 that has passed through the polarization dependent wavelength-separating film 30 is input to the light-emitting part 10, with the plane of polarization rotated in one direction by about 45 degrees by the magnet-free Faraday rotator 20. However, since the plane of polarization of the reflected and returned light input to the light-emitting part 10 is orthogonal to the plane of polarization of the light L1 generated in the light-emitting part 10, the operation of the light-emitting part 10 is substantially unaffected.

In this manner, according to the optical transceiver, the polarizer 121 and the analyzer 123 of the constituents of the optical isolator 120 in the conventional configuration as shown in FIG. 6 are omitted. The magnet-free Faraday rotator 20 is used instead of the Faraday rotator 122 and the magnet 124, and the polarization dependent wavelength-separating film 30 is formed on one plane of the magnet-free Faraday rotator 20 on the optical fiber 40 side. As a result, the number of optical parts can be reduced while maintaining the same function as in the conventional configuration, thereby enabling miniaturization of the single-core bidirectional optical transceiver. As one specific example, the distance between the light-emitting part 10 and the end face of the optical fiber 40 can be shortened to about 1.3 mm in the optical path length taking the refractive index into consideration, by omitting the polarizer 121 and the analyzer 123. Moreover, insertion loss can be reduced due to omission of the polarizer and the analyzer.

Since the operation of the magnet-free Faraday rotator 20 does not depend on the direction of the plane of polarization of the incident light, adjustment of the plane of polarization at the time of incidence of the light L1 generated in the light-emitting part 10 onto the magnet-free Faraday rotator 20 is not required.

On the other hand, an operation of the polarization dependent wavelength-separating film 30 with respect to the light L1 changes according to the direction of the plane of polarization of the light L1. Therefore, the plane of polarization of the light L1 and the polarization direction of the polarization dependent wavelength-separating film 30 need to be adjusted. However, these adjustments can be performed simultaneously with the rotation adjustment for making the light L2 enter into the light-receiving part 50. Hence, the number of adjustments can be considerably reduced.

In other words, a loss change of the polarization dependent wavelength-separating film 30 due to an angle of the plane of polarization in a wavelength range of the light L1 is gradual. Therefore, adjustment of the plane of polarization for the light L1 and adjustment of the light-receiving position for the light L2 are determined simultaneously by determining the rotation direction of the polarization dependent wavelength-separating film 30 by adjustment of the light L2 to the light-receiving part 50, after determination of an angle between the light-emitting part 10 and the polarization dependent wavelength-separating film 30 at the time of installation.

The relation between the rotation angle and the loss in the wavelength range of the light L1 is gradual as shown in FIG. 8, and for example, even if a deviation due to rotation is 15 degrees, a loss increase can be suppressed to 0.15 dB. Therefore, even if the plane of polarization deviates from an optimum angle due to the adjustment of the light-receiving position for the light L2, the deviation can be suppressed within an adjustment tolerance of the light L1.

Next is a description of a second embodiment of the present invention.

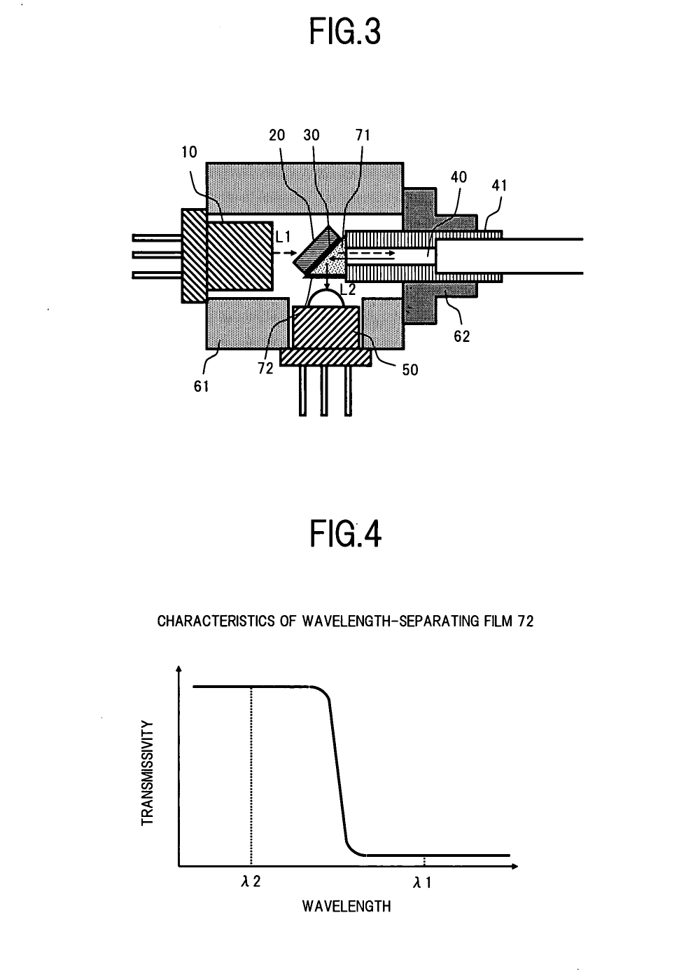

FIG. 3 is a cross-sectional view showing a configuration of an optical transceiver according to the second embodiment of the present invention.

In FIG. 3, the optical transceiver of the second embodiment is provided with a right angle prism 71 on the end faces of the optical fiber 40 and the ferrule 41 in the configuration of the aforementioned first embodiment shown in FIG. 1. The polarization dependent wavelength-separating film 30 formed on the magnet-free Faraday rotator 20 is fixed to an inclined face of the right angle prism 71, and a wavelength-separating film 72 is formed on a surface of the right angle prism 71 facing the light-receiving part 50.

The right angle prism 71 is a general prism having a shape of a right angles isosceles prism. The right angle prism 71 preferably has the same refractive index as that of the optical fiber 40. The wavelength-separating film 72 has a transmission wavelength characteristic, for example as shown in FIG. 4, and transmits the light of wavelength λ2, and reflects the light of wavelength λ1. The wavelength-separating film 72 has no polarization dependence.

In the configuration of the first embodiment described above, the S-polarization components of the reflected and returned light having wavelength λ1 reflected by the polarization dependent wavelength-separating film 30 may enter into the light-receiving part 50, thereby causing malfunction of the light-receiving part 50. Therefore in the optical transceiver in the second embodiment, the right angle prism 71 is arranged in a space in between the polarization dependent wavelength-separating film 30, the optical fiber 40, and the light-receiving part 50, and the wavelength-separating film 72 that transmits the light of wavelength λ2 and reflects the light of wavelength λ1 is provided on a surface of the right angle prism 71 facing the light-receiving part 50. As a result, input of the reflected and returned light of wavelength λ1 to the light-receiving part 50 can be prevented, enabling avoidance of malfunction of the light-receiving part 50. Since the right angle prism 71 having the same refractive index as that of the optical fiber 40 is used, a loss due to a difference in refractive index between the optical fiber 40 and air can also be prevented. Moreover, since the right angle prism 71 is fixed to the end faces of the optical fiber 40 and the ferrule 41, and the polarization dependent wavelength-separating film 30 is fixed to the inclined face of the right angle prism 71, positioning of the magnet-free Faraday rotator 20 and the polarization dependent wavelength-separating film 30 relative to the optical fiber 40 and the light-receiving part 50 becomes easy, thereby also enabling improvement in productivity.

In the second embodiment, the wavelength-separating film 72 is provided on the right angle prism 71. However, in the configuration of the first embodiment before the right angle prism 71 is provided, it is of course also possible to arrange a wavelength-separating film formed on a glass plate or the like, in a space between the polarization dependent wavelength-separating film 30 and the light-receiving part 50.

Next is a description of a third embodiment of the present invention.

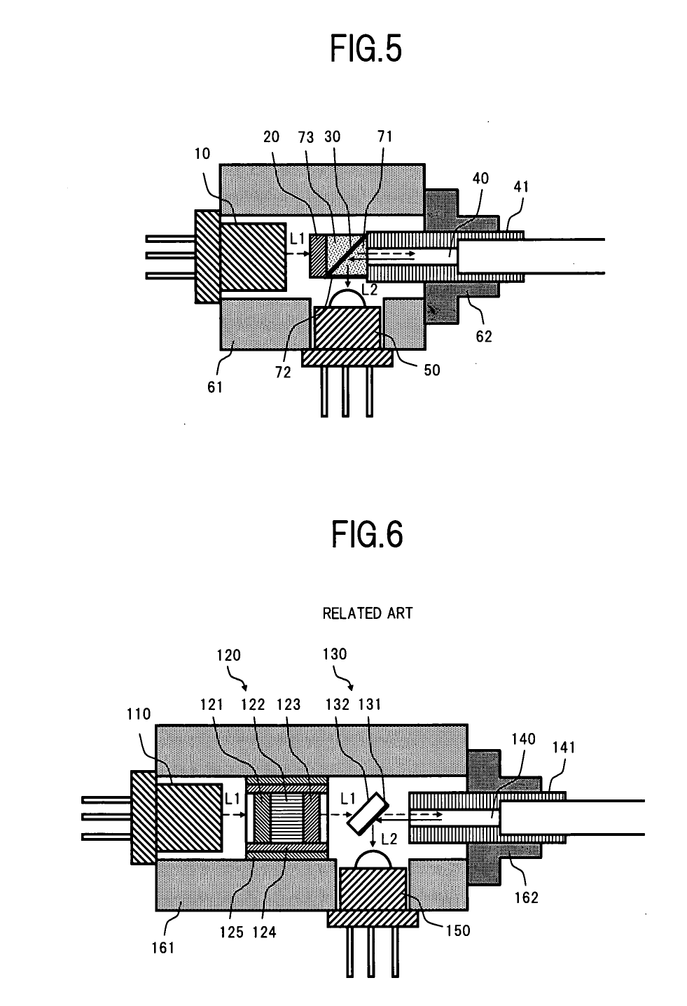

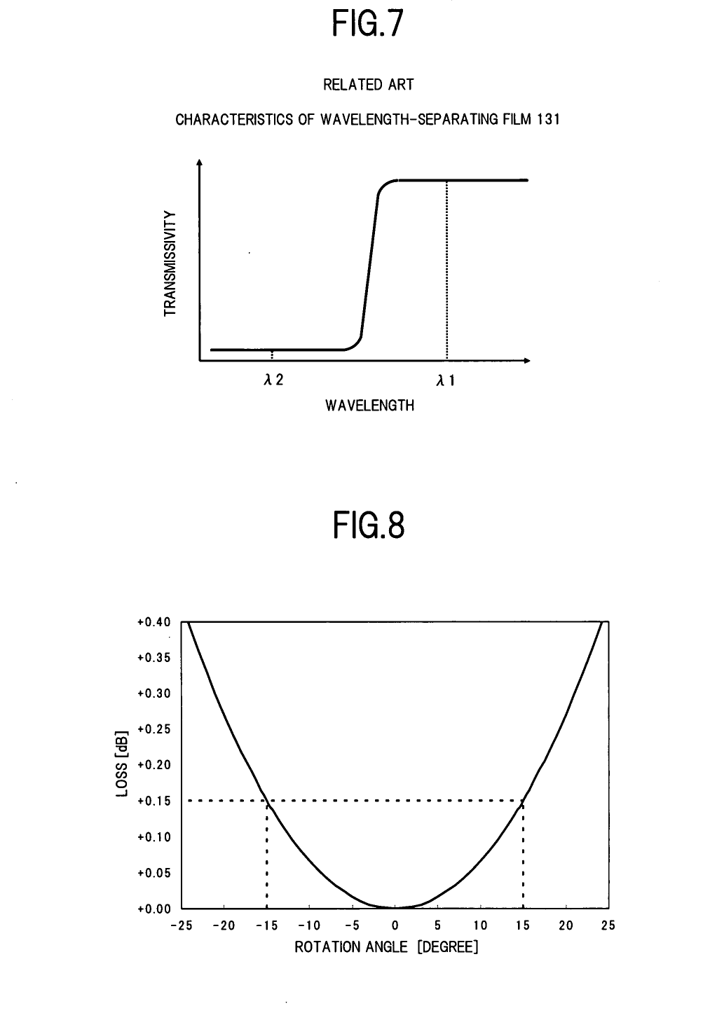

FIG. 5 is a cross-sectional view showing a configuration of an optical transceiver according to the third embodiment of the present invention.

In FIG. 5, the optical transceiver of the third embodiment is one where a right angle prism 73 similar to the right angle prism 71 is added to the configuration of the second embodiment shown in FIG. 3, the inclined faces of the two right angle prisms 71 and 73 are made to face each other and the polarization dependent wavelength-separating film 30 is formed therebetween, and the magnet-free Faraday rotator 20 is fixed to a surface of the right angle prism 73 facing the light-emitting part 10. More specifically, if the size of a cubic prism combining the two right angle prisms 71 and 73 is made, for example, about 1 mm square, a magnet-free Faraday rotator 20 with a thickness of about 0.5 mm and a size of about 1 mm square corresponding to an external shape of the prism can be used.

The characteristic of the magnet-free Faraday rotator 20 is such that the plane of polarization of light propagating in parallel with the optical axis of the light L1 emitted from the light-emitting part 10 is rotated in one direction by about 45 degrees, as in the first and the second embodiments. Moreover the characteristics of the polarization dependent wavelength-separating film 30 and the wavelength-separating film 72 are the same as those in the first and the second embodiments (refer to FIGS. 2 and 4).

According to the optical transceiver having the configuration described above, the same operation and effect as those in the second embodiment can be obtained.

What is claimed is:

1. An optical transceiver that transmits light of a first wavelength to an optical fiber, and receives light of a second wavelength different to the first wavelength transmitted inside said optical fiber in an opposite direction to the light of the first wavelength, said optical transceiver comprising:
a light-emitting part that outputs linearly polarized light of the first wavelength towards an end face of said optical fiber;
a Faraday rotator arranged on an optical axis between said light-emitting part and the end face of said optical fiber, for rotating a plane of polarization of light propagating in parallel with the optical axis, in one direction by about 45 degrees;
a polarization dependent wavelength separator positioned on the optical axis between said Faraday rotator and the end face of said optical fiber, and arranged so that the light of the first wavelength output from said light-emitting part and that has passed through said Faraday rotator, enters therein as P-polarized light, and which has such characteristics that it transmits the P-polarized light of the first wavelength and emits this in the same direction as the optical axis, and reflects S-polarized light of the first wavelength and the light of the second wavelength and emits the reflected light in a direction different from the optical axis; and
a light-receiving part that receives the light of the second wavelength output from the end face of said optical fiber and reflected by said polarization dependent wavelength separator.

2. An optical transceiver according to claim 1, wherein
said Faraday rotator is configured using a magnet-free Faraday rotator,
and said polarization dependent wavelength separator is fixed on a plane positioned on said optical fiber side of said magnet-free Faraday rotator.

3. An optical transceiver according to claim 2, wherein
said magnet-free Faraday rotator is arranged with a normal direction of a plane on which said polarization dependent wavelength-separating film is fixed, inclined by about 45 degrees with respect to the direction of the optical axis between said light-emitting part and the end face of said optical fiber.

4. An optical transceiver according to claim 1, wherein there is provided a wavelength separator having transmission characteristics such that it transmits light of the second wavelength and reflects light of the first wavelength, arranged between said polarization dependent wavelength separator and said light-receiving part.

5. An optical transceiver according to claim 4, wherein there is provided a first right angle prism that is fixed to the end face of said optical fiber,
and said polarization dependent wavelength separator is fixed to an inclined face of said first right angle prism,
and said wavelength separator is fixed to a face of said first right angle prism that faces said light-receiving part.

6. An optical transceiver according to claim 5, wherein
said Faraday rotator is configured using a magnet-free Faraday rotator,
and said polarization dependent wavelength separator is fixed between a plane positioned on said optical fiber side of said magnet-free Faraday rotator, and the inclined face of said first right angle prism.

7. An optical transceiver according to claim 5, wherein
said first right angle prism has the same refractive index as that of said optical fiber.

8. An optical transceiver according to claim 4, wherein there is provided;
a first right angle prism that is fixed to the end face of said optical fiber, and
a second right angle prism that is arranged with respect to said first right angle prism with mutual inclined faces facing each other,
and said polarization dependent wavelength separator is fixed between inclined faces of said first and second right angle prisms,
said Faraday rotator is fixed to a face of said second right angle prism that faces said light-emitting part,
and said wavelength separator is fixed to a face of said first right angle prism that faces said light-receiving part.

9. An optical transceiver according to claim 8, wherein
said first and second right angle prisms have the same refractive index as that of said optical fiber.
